(19) United States
(12) Patent Application Publication
(10) Pub. No.: US 2026/0303632 A1
(43) Pub. Date: Oct. 1, 2026

(54) MONITORING SYSTEM AND CONTROL METHOD

(71) Applicant: Panasonic Automotive Systems Co., Ltd., Kanagawa (JP)

(72) Inventors: Tomonori MITSUGI, Tokyo (JP); Ryo HIRANO, Osaka (JP); Tomoyuki HAGA, Nara (JP)

(73) Assignee: Panasonic Automotive Systems Co., Ltd., Kanagawa (JP)

(21) Appl. No.: 19/442,469

(22) Filed: Jan. 7, 2026

(30) Foreign Application Priority Data
Mar. 27, 2025 (JP) 2025-052852

(51) Int. Cl. H04L 9/40; H04L 67/12

(52) U.S. Cl. CPC H04L 63/1425; H04L 63/1441; H04L 67/12

(57) ABSTRACT

A monitoring system includes: an interregional communicator that controls communication between a first region and a second region; and a communication monitor that monitors the communication between the first region and the second region. The communication monitor includes multistage filters that sequentially inspect a specific communication in which the first region is a transmission source and the second region is a destination. When an n-th stage filter among the multistage filters determines, as a result of inspecting the specific communication, that the specific communication is allowed to pass through to the second region, (i) the specific communication is passed through to the second region while bypassing one or more filters from an (n + 1)-th stage filter and onward among the multistage filters, and in parallel with (i), (ii) the specific communication is inspected by the one or more filters from the (n + 1)-th stage filter and onward.

### CROSS REFERENCE TO RELATED APPLICATION

The present application is based on and claims priority of Japanese Patent Application No. 2025-052852 filed on Mar. 27, 2025.

### FIELD

The present disclosure relates to a monitoring system and a control method.

### BACKGROUND

In recent years, in conjunction with the evolving development of advanced vehicle functions, such as autonomous driving and the like, the types of vehicle systems being provided in vehicles continues to become more complex. Specifically, there is a trend toward taking functions that were each conventionally provided in separate units of a plurality of electronic control units (ECUs) and consolidating them into a single ECU. In this consolidation of ECUs, for example, external connection functions and vehicle control functions provided in a vehicle system are implemented in two different regions using a virtualization technology or a container technology for logically separating the vehicle system into a plurality of software regions (hereinafter simply referred to as “regions”).

In order to achieve the functions of a vehicle, since it is necessary to coordinate operation between two regions, a monitoring system that monitors communication between the two regions has been proposed (Patent Literature (PTL) 1, for example). In the conventional monitoring system, when a region in which an external connection function is implemented is attacked, for example, communication between the two regions is blocked and the communication is inspected in order to protect a region in which a vehicle control function is implemented from being attacked.

### CITATION LIST

### PATENT LITERATURE

PTL 1: Japanese Patent No. 7426640

### SUMMARY

The above-mentioned conventional monitoring system can be improved upon.

In view of this, the present disclosure provides a monitoring system and a control method that can further improve upon the related art.

A monitoring system according to one aspect of the present disclosure monitors a vehicle system logically separated into a first region and a second region that has a security level higher than a security level of the first region, and the monitoring system includes: an interregional communicator that controls communication between the first region and the second region; and a communication monitor that monitors the communication between the first region and the second region, wherein the communication monitor includes multistage filters that sequentially inspect a specific communication in which the first region is a transmission source and the second region is a destination, and when an n-th stage filter among the multistage filters determines, as a result of inspecting the specific communication, that the specific communication is allowed to pass through to the second region, (i) the specific communication is passed through to the second region while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one.

It should be noted that these generic and specific aspects may be implemented as a system, a method, an integrated circuit, a computer program, or a computer-readable recording medium, such as a compact disc-read only memory (CD-ROM), or may be implemented as any combination of a system, a method, an integrated circuit, a computer program, and a recording medium.

The monitoring system and the like according to one aspect of the present disclosure can further improve upon the related art.

### BRIEF DESCRIPTION OF DRAWINGS

These and other advantages and features of the present disclosure will become apparent from the following description thereof taken in conjunction with the accompanying drawings that illustrate specific embodiments of the present disclosure.

FIG. 1 is a block diagram illustrating a configuration of a vehicle system according to Embodiment 1.

FIG. 2 is a block diagram illustrating a configuration of a monitoring system according to Embodiment 1.

FIG. 3 is a block diagram for describing a function of a communication monitor according to Embodiment 1.

FIG. 4 is a sequence diagram for describing an example of inspection processes of the communication monitor according to Embodiment 1.

FIG. 5 is a sequence diagram for describing another example of inspection processes of the communication monitor according to Embodiment 1.

FIG. 6 is a sequence diagram for describing an example of notification processes of the communication monitor according to Embodiment 1.

FIG. 7 is a diagram illustrating an example of content of notifications sent from the communication monitor according to Embodiment 1.

FIG. 8 is a block diagram for describing an example of handling processes of an anomaly handler according to Embodiment 1.

FIG. 9 is a flowchart illustrating the flow of operation of the communication monitor according to Embodiment 1.

FIG. 10 is a flowchart illustrating the flow of operation of the anomaly handler according to Embodiment 1 in a case in which a specific communication is a file.

FIG. 11 is a flowchart illustrating the flow of operation of the anomaly handler according to Embodiment 1 in a case in which the specific communication is an attack communication.

FIG. 12 is a flowchart illustrating the flow of operation of the anomaly handler according to Embodiment 1 in a case in which the specific communication is immediately blocked.

FIG. 13 is a block diagram illustrating a configuration of a monitoring system according to Embodiment 2.

### DESCRIPTION OF EMBODIMENTS

### Underlying Knowledge Forming Basis of the Present Disclosure

In relation to the technique described in the “Background” section, the inventors have found the following point to be problematic.

In the above-mentioned conventional monitoring system, for example, when communication is blocked between two regions and the communication is inspected while a vehicle is being driven, there is a risk that a vehicle control function will be prevented from operating normally and driving safety of the vehicle will decrease.

In order to overcome this problematic point, the inventors have conceived of the monitoring system and the control method described below.

### Technique 1

A monitoring system that monitors a vehicle system logically separated into a first region and a second region that has a security level higher than a security level of the first region, the monitoring system includes: an interregional communicator that controls communication between the first region and the second region; and a communication monitor that monitors the communication between the first region and the second region, in which the communication monitor includes multistage filters that sequentially inspect a specific communication in which the first region is a transmission source and the second region is a destination. When an n-th stage filter among the multistage filters determines, as a result of inspecting the specific communication, that the specific communication is allowed to pass through to the second region, (i) the specific communication is passed through to the second region while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one.

According to Technique 1, when an n-th stage filter among the multistage filters determines, as a result of inspecting the specific communication, that the specific communication is allowed to pass through to the second region, (i) the specific communication is tentatively passed through to the second region while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one. Accordingly, since the specific communication is allowed to be tentatively passed through from the n-th stage filter to the second region, functions of the second region do not need to be interrupted even when a vehicle is being driven, for example. Furthermore, as a result of inspection of the one or more filters from the (n + 1)-th stage filter and onward, even when an anomaly is identified in the specific communication, notification of this matter can be provided after the fact. As a result, communication between the first region and the second region can be monitored while ensuring driving safety of the vehicle.

### Technique 2

The monitoring system according to Technique 1, in which when the specific communication is determined to be anomalous as a result of the multistage filters inspecting the specific communication, the communication monitor provides notification that the specific communication is anomalous.

According to Technique 2, notification that the specific communication is anomalous can be provided.

### Technique 3

The monitoring system according to Technique 2, further includes: an anomaly handler that executes a handling process on the specific communication based on the notification that the specific communication is anomalous from the communication monitor.

According to Technique 3, when the specific communication is anomalous, the handling process can be performed on the specific communication.

### Technique 4

The monitoring system according to Technique 3, in which the vehicle system is further logically separated into the first region, the second region, and an inspection region isolated from the first region and the second region. When the specific communication is a transmission of a malicious file from the first region to the second region, as the handling process, the anomaly handler moves the malicious file from the second region to the inspection region, and inspects the malicious file in the inspection region.

According to Technique 4, the malicious file can be inspected in the inspection region that is isolated from the first region and the second region with a high degree of security.

### Technique 5

The monitoring system according to Technique 4, in which after inspecting the malicious file in the inspection region, the anomaly handler deletes the inspection region.

According to Technique 5, security can be enhanced.

### Technique 6

The monitoring system according to Technique 3, in which when the specific communication is a transmission of a malicious file from the first region to the second region, as the handling process, the anomaly handler deletes the second region together with the malicious file, and generates a third region that has a function identical to a function of the second region.

According to Technique 6, security can be enhanced.

### Technique 7

The monitoring system according to any one of techniques 1 to 6, in which the multistage filters sequentially inspect the specific communication based on a state of a vehicle in which the vehicle system is provided.

According to Technique 7, the state of the vehicle can be taken into consideration and the specific communication can be sequentially inspected.

### Technique 8

A control method for use in a monitoring system that monitors a vehicle system logically separated into a first region and a second region that has a security level higher than a security level of the first region, the control method includes: controlling communication between the first region and the second region; and monitoring the communication between the first region and the second region, in which in the monitoring, when multistage filters are used to sequentially inspect a specific communication in which the first region is a transmission source and the second region is a destination, and an n-th stage filter among the multistage filters determines, as a result of inspecting the specific communication, that the specific communication is allowed to pass through to the second region, (i) the specific communication is passed through to the second region while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one.

According to Technique 8, in the same manner as in the above-mentioned Technique 1, communication between the first region and the second region can be monitored while ensuring driving safety of the vehicle.

It should be noted that these generic and specific aspects may be implemented as a system, a method, an integrated circuit, a computer program, or a computer-readable recording medium, such as a CD-ROM, or may be implemented as any combination of a system, a method, an integrated circuit, a computer program, and a recording medium.

Hereinafter, exemplary embodiments will be specifically described with reference to the drawings.

It should be noted that the embodiments described below merely illustrate generic or specific examples of the present disclosure. The numerical values, shapes, materials, elements, the arrangement and connection states of the elements, steps, the order of the steps, etc., described in the following embodiments are mere examples, and are therefore not intended to limit the present disclosure. Accordingly, among elements in the following embodiments, those not appearing in any of the independent claims that indicate the broadest concepts of the present disclosure will be described as optional elements.

### Embodiment 1

### 1. Vehicle System Configuration

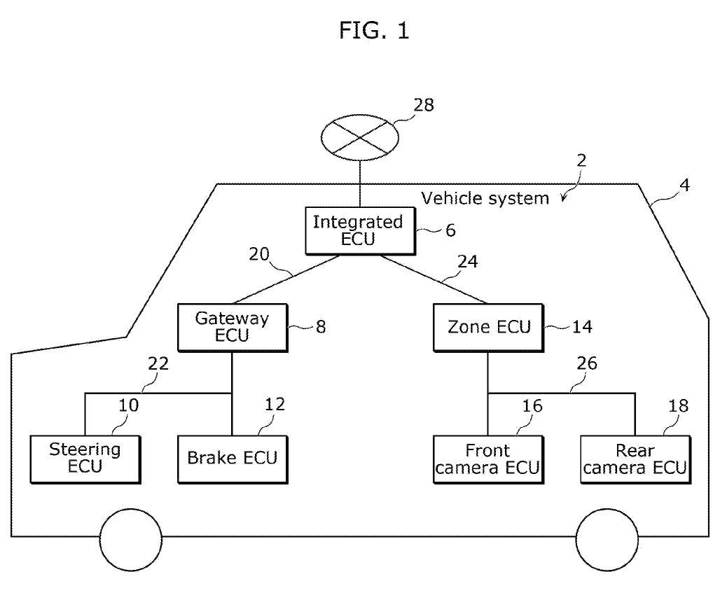

First, a configuration of vehicle system 2 according to Embodiment 1 will be described with reference to FIG. 1. FIG. 1 is a block diagram illustrating a configuration of vehicle system 2 according to Embodiment 1.

As illustrated in FIG. 1, vehicle system 2 is provided in vehicle 4 that is, for example, an automobile or the like. Vehicle system 2 is, for example, applied to an autonomous driving system that performs control so that driving operations of vehicle 4, such as acceleration, deceleration, steering, and braking, are autonomously performed by an advanced driver assistance system (ADAS).

Vehicle system 2 includes integrated ECU 6, gateway ECU 8, steering ECU 10, brake ECU 12, zone ECU 14, front camera ECU 16, and rear camera ECU 18.

It should be noted that integrated ECU 6 is communicably connected to gateway ECU 8 via controller area network (CAN) 20. Furthermore, gateway ECU 8, steering ECU 10, and brake ECU 12 are communicably connected to each other via CAN 22.

Furthermore, integrated ECU 6 is communicably connected to zone ECU 14 via Ethernet (registered trademark) 24. Furthermore, zone ECU 14, front camera ECU 16, and rear camera ECU 18 are communicably connected to each other via Ethernet 26. Additionally, integrated ECU 6 is communicably connected to communicate externally from vehicle 4 via external network 28, which is the Internet or the like.

Integrated ECU 6 executes (a) external communication control in which data (files) and the like are transmitted and received via external network 28, (b) internal communication control in which data and the like are transmitted and received via CAN 20 and Ethernet 24, (c) vehicle control in which instructions on control of vehicle 4 are provided to each of gateway ECU 8 and zone ECU 14 via CAN 20 and Ethernet 24, and (d) video output and the like to an infotainment system or an instrument panel. Furthermore, integrated ECU 6 monitors for the occurrence of a security anomaly (such as unauthorized communication access, for example) in vehicle system 2.

Gateway ECU 8 relays data that is transmitted and received between integrated ECU 6, steering ECU 10, and brake ECU 12.

Steering ECU 10 controls steering performed using a steering wheel provided in vehicle 4.

Brake ECU 12 controls actuation of brakes provided in vehicle 4.

Note that in addition to steering ECU 10 and brake ECU 12, vehicle system 2 uses ECUs that control an engine, a body, or the like of vehicle 4 to perform various controls, such as driving, turning, and stopping of vehicle 4.

Zone ECU 14 relays data that is transmitted and received between integrated ECU 6, front camera ECU 16, and rear camera ECU 18.

Front camera ECU 16 obtains video of an area ahead of vehicle 4 that is captured by a front camera provided on a front portion of vehicle 4.

Rear camera ECU 18 obtains video of an area behind vehicle 4 that is captured by a rear camera provided on a rear portion of vehicle 4.

### 2. Functional Configuration of Monitoring System

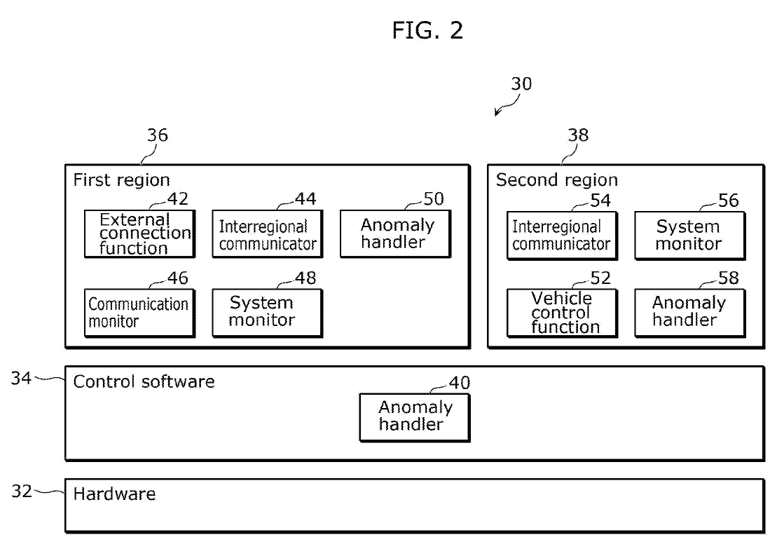

Next, a configuration of monitoring system 30 according to Embodiment 1 will be described with reference to FIG. 2. FIG. 2 is a block diagram illustrating a configuration of monitoring system 30 according to Embodiment 1.

Monitoring system 30 is a system for monitoring vehicle system 2, and is implemented by the above-mentioned integrated ECU 6 (see FIG. 1). As illustrated in FIG. 2, monitoring system 30 includes hardware 32, control software 34, first region 36, and second region 38.

It should be noted that vehicle system 2 is, for example, logically separated, by a virtualization technology or a container technology, into first region 36 that is a software region and second region 38 that is a software region with a security level that is higher than a security level of first region 36. Here, since memory and namespaces of functions belonging to first region 36 and functions belonging to second region 38 are separated from each other, they are unable to interfere with each other unless a predetermined means of communication is used.

For example, hardware 32 includes a processor, such as a central processing unit (CPU) or an ECU or the like, and provides an execution environment for a plurality of computer programs. It should be noted that hardware 32 may include a single processor, or alternatively, may include a plurality of processors.

Control software 34 is virtualization software that controls execution for each of first region 36 and second region 38, and is executed in hardware 32. Control software 34 makes it possible to virtualize and implement a plurality of different operating systems (first region 36 and second region 38) in a single hardware 32. It should be noted that control software 34 may, for example, be a type-1 hypervisor that directly runs on hardware 32, and may be a type-2 hypervisor that runs on an operating system that directly runs on hardware 32.

Control software 34 includes anomaly handler 40. Anomaly handler 40 executes a handling process on an anomaly detected by communication monitor 46 based on a notification from communication monitor 46 (will be described later) of first region 36.

First region 36 includes external connection function 42, interregional communicator 44, communication monitor 46, system monitor 48, and anomaly handler 50. It should be noted that each function implemented in first region 36 is, for example, implemented by a virtual machine or the like.

External connection function 42 functions to communicably connect vehicle 4 for external communication via external network 28 (see FIG. 1). Specifically, for example, external connection function 42 downloads files (data) from outside of vehicle 4 via external network 28.

Interregional communicator 44 controls communication between first region 36 and second region 38. Specifically, for example, based on instructions from communication monitor 46, interregional communicator 44 transmits files downloaded by external connection function 42 from first region 36 to second region 38.

Communication monitor 46 monitors communication performed by interregional communicator 44 between first region 36 and second region 38. When an anomaly is detected in communication between first region 36 and second region 38, communication monitor 46 notifies anomaly handler 50 of this matter. The functionality of communication monitor 46 will later be described in detail.

System monitor 48 monitors behavior of each function of first region 36. When an anomaly is detected in first region 36, system monitor 48 notifies anomaly handler 50 of this matter.

Anomaly handler 50 executes a handling process on a communication anomaly detected by communication monitor 46 based on a notification from communication monitor 46. Furthermore, anomaly handler 50 executes a handling process on an anomaly of first region 36 detected by system monitor 48 based on a notification from system monitor 48. The functionality of anomaly handler 50 will later be described in detail.

Second region 38 includes vehicle control function 52, interregional communicator 54, system monitor 56, and anomaly handler 58. It should be noted that each function implemented in second region 38 is, for example, implemented by a virtual machine or the like.

Vehicle control function 52 is a function that provides instructions on control of vehicle 4 for steering ECU 10, brake ECU 12, and the like, for example, via CAN 20 and Ethernet 24 (see FIG. 1).

Interregional communicator 54 functions to control communication between second region 38 and first region 36. Specifically, interregional communicator 54 receives files transmitted from first region 36, for example.

System monitor 56 monitors behavior of each function of second region 38. When an anomaly is detected in second region 38, system monitor 56 notifies anomaly handler 58 of this matter.

Anomaly handler 58 executes a handling process on a communication anomaly detected by communication monitor 46 based on a notification from communication monitor 46 of first region 36. Furthermore, anomaly handler 58 executes a handling process on an anomaly of second region 38 detected by system monitor 56 based on a notification from system monitor 56.

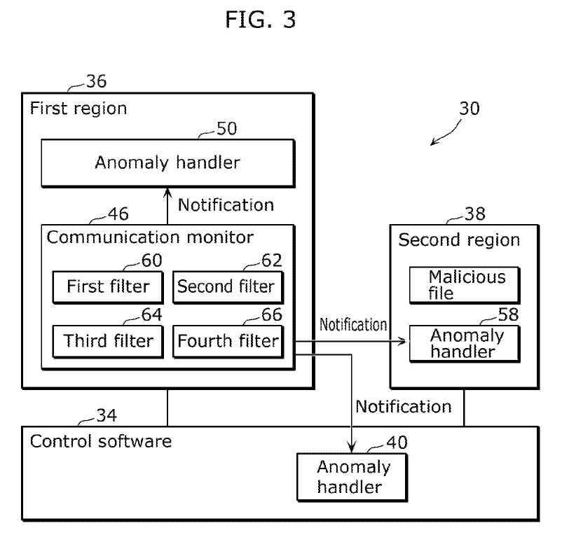

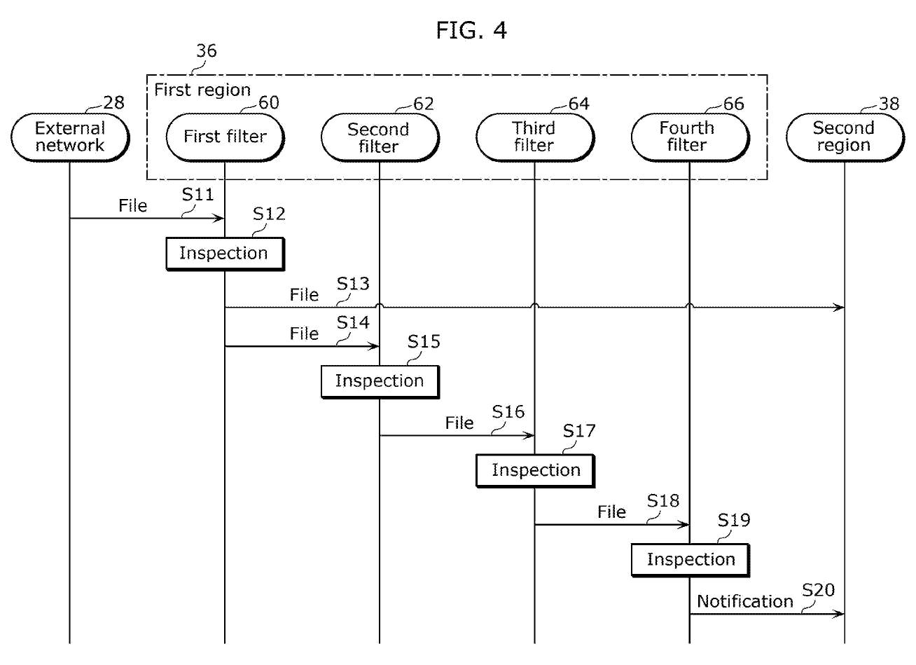

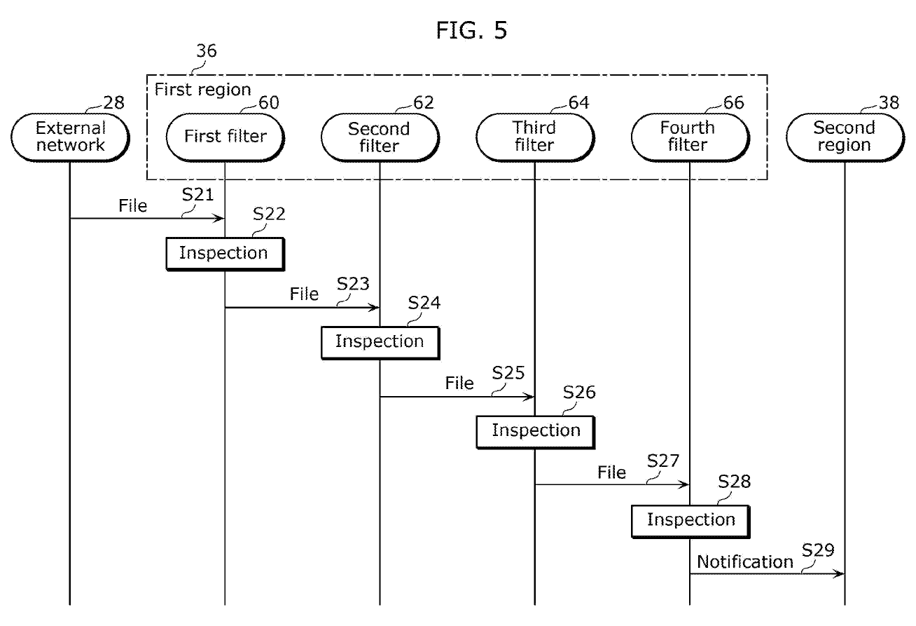

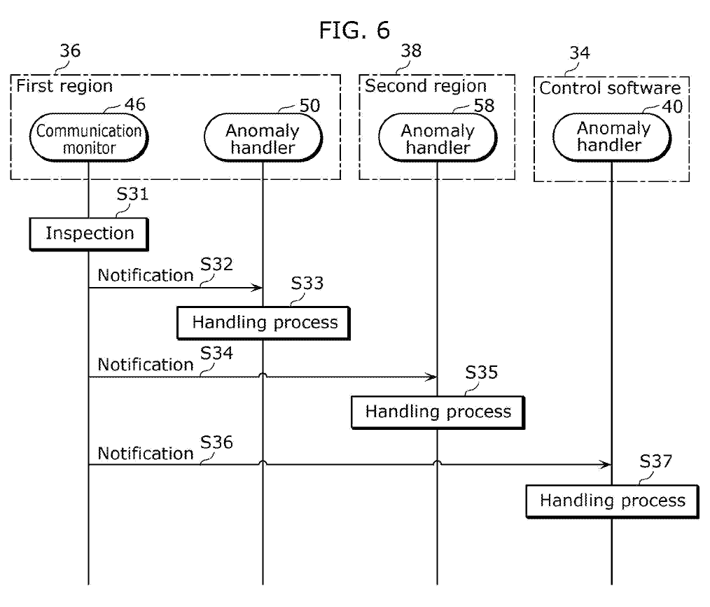

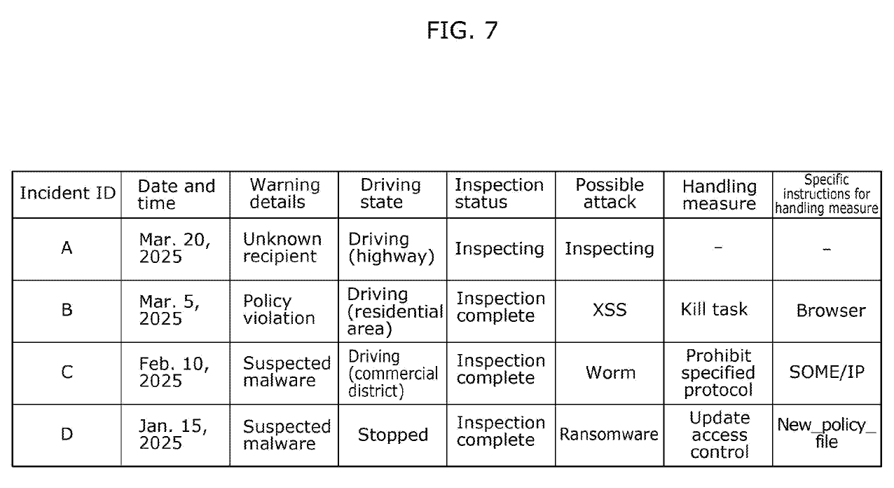

Next, functions of communication monitor 46 will be described in detail with reference to FIGS. 3 through 7. FIG. 3 is a block diagram for describing a function of communication monitor 46 according to Embodiment 1. FIG. 4 is a sequence diagram for describing an example of inspection processes of communication monitor 46 according to Embodiment 1. FIG. 5 is a sequence diagram for describing another example of inspection processes of communication monitor 46 according to Embodiment 1. FIG. 6 is a sequence diagram for describing an example of notification processes of communication monitor 46 according to Embodiment 1. FIG. 7 is a diagram illustrating an example of content of notifications sent from communication monitor 46 according to Embodiment 1.

Communication monitor 46 includes filters that are included in multistage filters that sequentially inspect a specific communication (for example, malware, a malicious file, or the like that is downloaded from external network 28) in which a transmission source is first region 36 and a destination is second region 38.

As illustrated in FIG. 3, the multistage filters include first filter 60, second filter 62, third filter 64, and fourth filter 66. First filter 60, second filter 62, third filter 64, and fourth filter 66 are respectively filters of a first stage, a second stage, a third stage, and a fourth stage, and inspection of the specific communication is sequentially performed in this order. The content of inspection performed for each of first filter 60, second filter 62, third filter 64, and fourth filter 66 is, for example, (a) communication payload, (b) attributes of the transmission destination or destination of the specific communication, (c) reliability of the transmission destination or the destination of the specific communication, (d) frequency of communication, and the like. It should be noted that the content of inspection performed for each of first filter 60, second filter 62, third filter 64, and fourth filter 66 is different from each other, and for example, as inspection progresses in this order, the content of inspection gradually becomes more detailed.

When an n-th stage filter among the multistage filters determines, as a result of inspecting the specific communication, that the specific communication is allowed to pass through to second region 38, (i) the specific communication is tentatively passed through (transmitted) to second region 38 while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one.

As a result of inspecting the specific communication based on a state of vehicle 4, the multistage filters may determine whether to allow the specific communication to tentatively pass through to second region 38. For example, when vehicle 4 is stopped, the multistage filters determine that the specific communication may be allowed to tentatively pass through to second region 38. Furthermore, for example, when vehicle 4 is driving on a highway or in a residential area or a commercial district, the multistage filters determine that the specific communication should not be allowed to tentatively pass through to second region 38.

Here, an example of inspection processes of communication monitor 46 in a case in which the specific communication is a malicious file (hereinafter simply referred to as a “file”) will be described with reference to FIG. 4.

As illustrated in FIG. 4, first, a file downloaded from external network 28 reaches first filter 60, among the multistage filters (S11).

Next, first filter 60 inspects the file (S12). As a result of inspecting the file, when it is determined that the file is allowed to be passed through to second region 38, first filter 60 allows the file to tentatively pass through to second region 38 while bypassing second filter 62, third filter 64, and fourth filter 66 (S13). In parallel with this, first filter 60 copies the file that is passed through to second region 38 for inspection purposes, and transmits the file copied for inspection purposes to second filter 62 (S14).

Next, second filter 62 inspects the file (S15). After the file is inspected, second filter 62 transmits the file to third filter 64 (S16).

Next, third filter 64 inspects the file (S17). After the file is inspected, third filter 64 transmits the file to fourth filter 66 (S18).

Next, fourth filter 66 inspects the file (S19).

Next, when it is determined that the file is anomalous, communication monitor 46 notifies anomaly handler 58 in second region 38 of this matter based on each of the inspection results of first filter 60, second filter 62, third filter 64, and fourth filter 66 (S20). Here, in addition to anomaly handler 58 in second region 38, communication monitor 46 may also notify anomaly handler 50 in first region 36 and anomaly handler 40 in control software 34 that the file is anomalous.

In the example illustrated in FIG. 4, although a case is described in which first filter 60 determines that the file is allowed to pass through to second region 38, this example is not limiting. As a result of second filter 62 inspecting the file, when it is determined that the file is allowed to be passed through to second region 38, second filter 62 may allow the file to tentatively pass through to second region 38 while bypassing third filter 64 and fourth filter 66. In parallel with this, second filter 62 may copy the file that is passed through to second region 38 for inspection purposes, and transmit the file copied for inspection purposes to third filter 64. In this case, first filter 60 does not allow the file to be tentatively passed through to second region 38.

Alternatively, as a result of third filter 64 inspecting the file, when it is determined that the file is allowed to be passed through to second region 38, third filter 64 may allow the file to tentatively pass through to second region 38 while bypassing fourth filter 66. In parallel with this, third filter 64 may copy the file that is passed through to second region 38 for inspection purposes, and transmit the file copied for inspection purposes to fourth filter 66. In this case, first filter 60 and second filter 62 do not allow the file to be tentatively passed through to second region 38.

Next, another example of inspection processes of communication monitor 46 in a case in which the specific communication is a malicious file will be described with reference to FIG. 5.

As illustrated in FIG. 5, first, a file downloaded from external network 28 reaches first filter 60, among the multistage filters (S21).

Next, first filter 60 inspects the file (S22). As a result of inspecting the file, when it is determined that the file is not allowed to be tentatively passed through to second region 38, first filter 60 transmits the file to second filter 62 (S23). In this case, first filter 60 does not allow the file to tentatively pass through to second region 38 while bypassing second filter 62, third filter 64, and fourth filter 66.

Next, second filter 62 inspects the file (S24). After the file is inspected, second filter 62 transmits the file to third filter 64 (S25).

Next, third filter 64 inspects the file (S26). After the file is inspected, third filter 64 transmits the file to fourth filter 66 (S27).

Next, fourth filter 66 inspects the file (S28).

Next, when it is determined that the file is anomalous, communication monitor 46 notifies anomaly handler 58 in second region 38 of this matter based on each of the inspection results of first filter 60, second filter 62, third filter 64, and fourth filter 66 (S29). Here, in addition to anomaly handler 58 in second region 38, communication monitor 46 may also notify anomaly handler 50 in first region 36 and anomaly handler 40 in control software 34 that the file is anomalous.

Next, an example of notification processing of communication monitor 46 will be described with reference to FIGS. 6 and 7. As illustrated in FIG. 6, communication monitor 46 inspects the file using first filter 60, second filter 62, third filter 64, and fourth filter 66 (S31).

Next, when it is determined that the file is anomalous, communication monitor 46 notifies anomaly handler 50 in first region 36 of this matter based on each of the inspection results of first filter 60, second filter 62, third filter 64, and fourth filter 66 (S32). With this, anomaly handler 50 executes a handling process on the file that has been determined to be anomalous (S33).

Furthermore, communication monitor 46 notifies anomaly handler 58 of second region 38 that the file is anomalous (S34). With this, anomaly handler 58 executes a handling process on the file that has been determined to be anomalous (S35).

Furthermore, communication monitor 46 notifies anomaly handler 40 of control software 34 that the file is anomalous (S36). With this, anomaly handler 40 executes a handling process on the file that has been determined to be anomalous (S37).

Here, an example of content of notifications sent from communication monitor 46 is illustrated in FIG. 7, for example. In the example illustrated in FIG. 7, a notification is table data in which an incident ID, a date and time at which an anomaly occurred, warning details, a driving state of vehicle 4, an inspection status, a possible attack, a handling measure, and specific instructions for the handling measure are associated with each other.

It should be noted that in FIG. 6, although steps S32, S34, and S36 are performed in this order, this example is not limiting, and steps S32, S34, and S36 may be performed simultaneously. Alternatively, in FIG. 6, although all of steps S32, S34, and S36 are performed, this example is not limiting, and only one of the steps or two of the steps need to be performed.

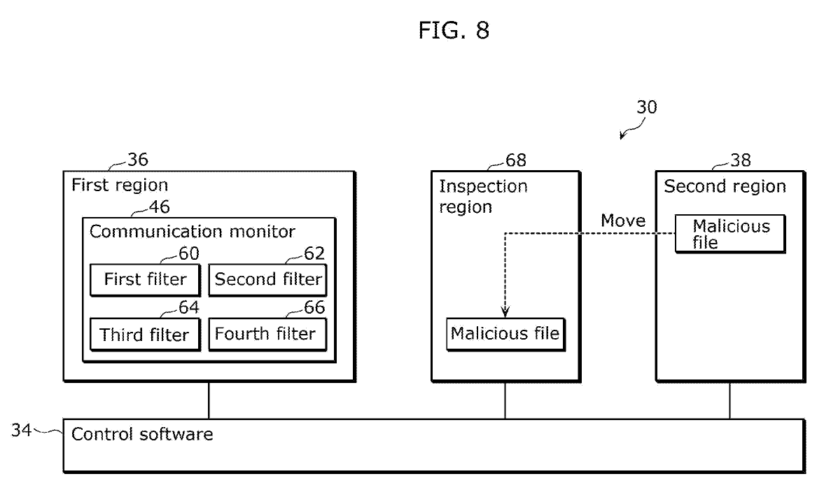

Next, an example of handling processes of anomaly handler 58 of second region 38 will be described with reference to FIG. 8. FIG. 8 is a block diagram for describing an example of handling processes of anomaly handler 58 according to Embodiment 1.

As illustrated in FIG. 8, the file that is passed through from first filter 60 as described above in step S13 in FIG. 4 is stored in second region 38. In this state, when it is determined that the file that is passed through to second region 38 is anomalous (the file is a malicious file), communication monitor 46 notifies anomaly handler 58 of second region 38 of this matter.

With this, anomaly handler 58 moves the file stored in second region 38 to inspection region 68 based on the notification from communication monitor 46. Next, anomaly handler 58 inspects the file that is moved to inspection region 68 in detail.

Here, inspection region 68 is a software region used for inspection purposes that is isolated from first region 36 and second region 38. In other words, vehicle system 2 is logically separated into first region 36, second region 38, and inspection region 68. It should be noted that inspection region 68 may be generated in advance, and may be generated when anomaly handler 58 receives a notification from communication monitor 46.

It should be noted that the above-mentioned handling processes of anomaly handler 58 may be executed by anomaly handler 40 or anomaly handler 50 instead of anomaly handler 58.

### 3. Operation of Monitoring System

### 3-1. Operation of Communication Monitor

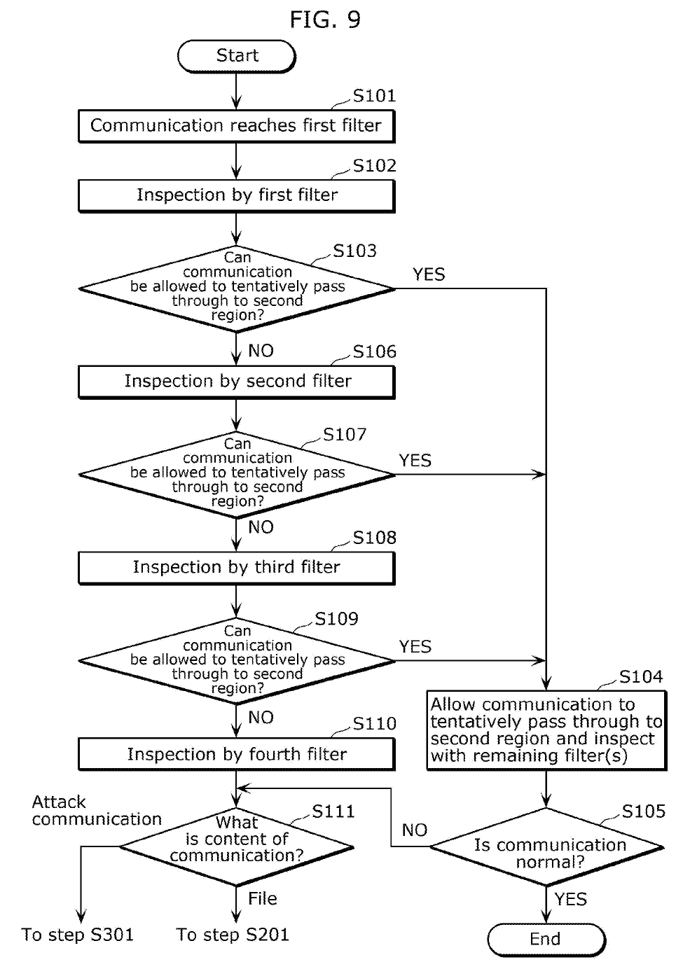

Operation of communication monitor 46 according to Embodiment 1 will be described with reference to FIG. 9. FIG. 9 is a flowchart illustrating the flow of operation of communication monitor 46 according to Embodiment 1.

As illustrated in FIG. 9, first, a specific communication (hereinafter simply referred to as “communication”) from external network 28 reaches first filter 60 among the multistage filters of communication monitor 46 (S101).

Next, first filter 60 inspects the specific communication (S102). As a result of inspecting the specific communication, when it is determined that the specific communication is allowed to be passed through to second region 38 (“YES” in S103), first filter 60 allows the specific communication to tentatively pass through to second region 38 while bypassing second filter 62, third filter 64, and fourth filter 66 (S104). In parallel with this, first filter 60 copies the specific communication that is passed through to second region 38 for inspection purposes, and the specific communication copied is inspected by second filter 62, third filter 64, and fourth filter 66 in this order (S104).

Next, when it is determined that the file is normal (“YES” in S105), communication monitor 46 terminates the process illustrated in the flowchart in FIG. 9 based on each of the inspection results of first filter 60, second filter 62, third filter 64, and fourth filter 66.

On the other hand, in step S105, when it is determined that the specific communication is anomalous (“NO” in S105), communication monitor 46 proceeds to step S111 as described later based on each of the inspection results of first filter 60, second filter 62, third filter 64, and fourth filter 66.

Returning to step S103, as a result of inspecting the specific communication, when it is determined that the specific communication is not allowed to be tentatively passed through to second region 38 (“NO” in S103), first filter 60 transmits the specific communication to second filter 62. In this case, first filter 60 does not allow the specific communication to pass through to second region 38 while bypassing second filter 62, third filter 64, and fourth filter 66.

Next, second filter 62 inspects the specific communication (S106). As a result of inspecting the specific communication, when it is determined that the specific communication is allowed to be passed through to second region 38 (“YES” in S107), processing proceeds to step S104, and second filter 62 allows the specific communication to tentatively pass through to second region 38 while bypassing third filter 64 and fourth filter 66 (S104). In parallel with this, second filter 62 copies the specific communication that is passed through to second region 38 for inspection purposes, and the specific communication copied is inspected by third filter 64 and fourth filter 66 in this order (S104). Subsequently, processing proceeds to the above-mentioned step S105.

Returning to step S107, as a result of inspecting the specific communication, when it is determined that the specific communication is not allowed to be tentatively passed through to second region 38 (“NO” in S107), second filter 62 transmits the specific communication to third filter 64.

Next, third filter 64 inspects the specific communication (S108). As a result of inspecting the specific communication, when it is determined that the specific communication is allowed to be passed through to second region 38 (“YES” in S109), processing proceeds to step S104, and third filter 64 allows the specific communication to tentatively pass through to second region 38 while bypassing fourth filter 66 (S104). In parallel with this, third filter 64 copies the specific communication that is passed through to second region 38 for inspection purposes, and the specific communication copied for inspection purposes is inspected by fourth filter 66 (S104). Subsequently, processing proceeds to the above-mentioned step S105.

Returning to step S109, as a result of inspecting the specific communication, when it is determined that the specific communication is not allowed to be tentatively passed through to second region 38 (“NO” in S109), third filter 64 transmits the specific communication to fourth filter 66.

Next, fourth filter 66 inspects the specific communication (S110).

Next, when it is determined that the file is anomalous, communication monitor 46 notifies anomaly handler 58 in second region 38 of this matter based on each of the inspection results of first filter 60, second filter 62, third filter 64, and fourth filter 66.

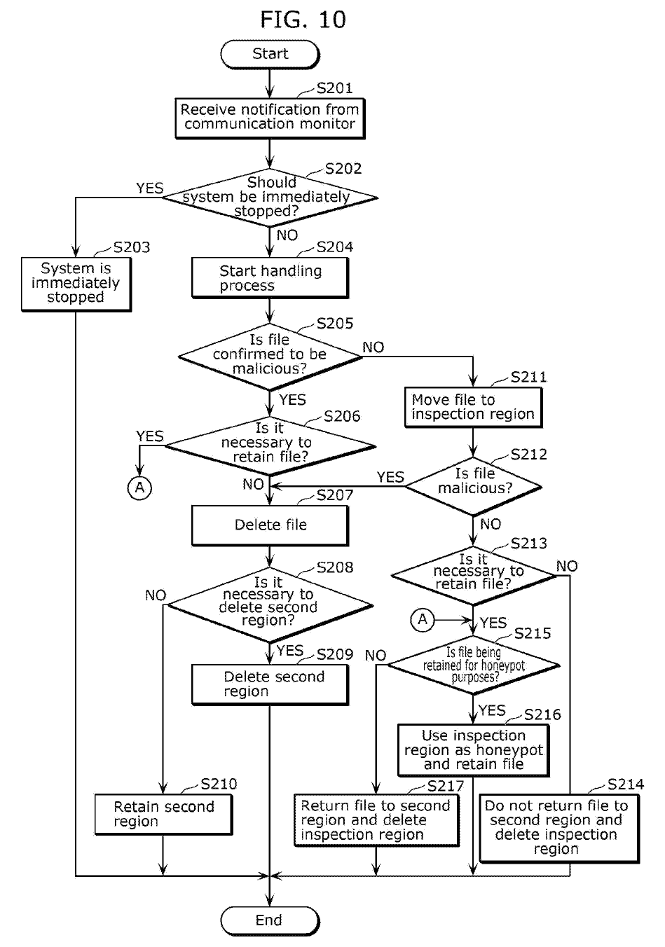

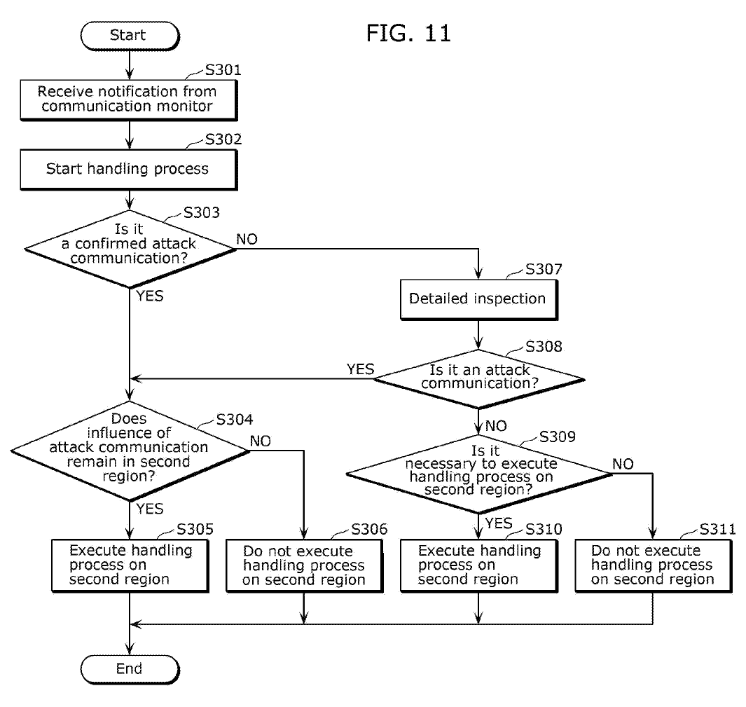

Subsequently, when the specific communication is a malicious file (“file” in S111), processing proceeds to step S201 in FIG. 10, and a handling process is performed by anomaly handler 58 as indicated in the flowchart in FIG. 10. On the other hand, when the specific communication is an attack communication, such as malware or the like (“attack communication” in S111), processing proceeds to step S301 in FIG. 11, and a handling process is performed by anomaly handler 58 as indicated in the flowchart in FIG. 11.

### 3-2. Operation of Anomaly Handler

Operation of anomaly handler 58 in a case in which a specific communication is a file will be described with reference to FIG. 10. FIG. 10 is a flowchart illustrating the flow of operation of anomaly handler 58 according to Embodiment 1 in a case in which a specific communication is a file.

Hereinafter, operation will be described of anomaly handler 58 in a case in which communication monitor 46 (i.e., either first filter 60, second filter 62, or third filter 64) allows a file to be tentatively passed through to second region 38.

As illustrated in FIG. 10, first, anomaly handler 58 receives notification from communication monitor 46 (S201).

Next, when it is determined that vehicle system 2 should be immediately stopped based on the notification from communication monitor 46 (“YES” in S202), anomaly handler 58 immediately stops vehicle system 2 (S203). Subsequently, the processing of the flowchart in FIG. 10 is terminated.

On the other hand, when it is determined that vehicle system 2 need not be stopped based on the notification from communication monitor 46 (“NO” in S202), anomaly handler 58 starts performing a handling process on the file (S204).

Next, when it is confirmed that the file is a malicious file (“YES” in S205), anomaly handler 58 determines whether it is necessary to retain the file stored in second region 38 (S206). When it is determined that it is necessary to retain the file (“YES” in S206), anomaly handler 58 proceeds to step S215 that will be described later.

On the other hand, when it is determined that it is not necessary to retain the file (“NO” in S206), anomaly handler 58 deletes the file stored in second region 38 (S207).

Next, anomaly handler 58 determines whether it is necessary to delete second region 38 (S208). When it is determined that it is necessary to delete second region 38 (“YES” in S208), anomaly handler 58 deletes second region 38 (S209). In this case, as a handling process, anomaly handler 58 may generate a third region that serves the same function as second region 38 that has been deleted. With this, the third region generated can be used in place of second region 38. Subsequently, the processing of the flowchart in FIG. 10 is terminated.

On the other hand, when it is determined that it is not necessary to delete second region 38 (“NO” in S208), anomaly handler 58 retains second region 38 as is (S210). Subsequently, the processing of the flowchart in FIG. 10 is terminated.

Returning to step S205, when it is not confirmed that the file is a malicious file (“NO” in S205), anomaly handler 58 moves the file stored in second region 38 to inspection region 68 (S211). With this, anomaly handler 58 inspects the file in inspection region 68 in detail.

Next, as a result of inspecting the file in inspection region 68, when it is determined that the file is a malicious file (“YES” in S212), anomaly handler 58 proceeds to the above-mentioned step S207.

On the other hand, as a result of inspecting the file, when it is confirmed that the file is not a malicious file (“NO” in S212), anomaly handler 58 determines whether it is necessary to retain the file stored in inspection region 68 (S213).

When it is determined that it is not necessary to retain the file (“NO” in S213), anomaly handler 58 does not return the file to second region 38 from inspection region 68, and deletes both inspection region 68 and the file (S214).

On the other hand, when it is determined that it is necessary to retain the file (“YES” in S213) and the file is being retained for honeypot purposes (“YES” in S215), anomaly handler 58 uses inspection region 68 as a honeypot and retains the file (S216). Subsequently, the processing of the flowchart in FIG. 10 is terminated.

Returning to step S213, when it is determined that it is necessary to retain the file (“YES” in S213) and the file is not being retained for honeypot purposes (“NO” in S215), anomaly handler 58 returns the file from inspection region 68 to second region 38 and deletes inspection region 68 (S217). Subsequently, the processing of the flowchart in FIG. 10 is terminated.

Next, operation of anomaly handler 58 in a case in which a specific communication is an attack communication will be described with reference to FIG. 11. FIG. 11 is a flowchart illustrating the flow of operation of anomaly handler 58 according to Embodiment 1 in a case in which a specific communication is an attack communication.

Hereinafter, operation will be described of anomaly handler 58 in a case in which communication monitor 46 (i.e., either first filter 60, second filter 62, or third filter 64) allows a specific communication to be tentatively passed through to second region 38.

As illustrated in FIG. 11, first, anomaly handler 58 receives notification from communication monitor 46 (S301).

Next, anomaly handler 58 starts performing a handling process on a specific communication based on the notification from communication monitor 46 (S302).

Next, when it is confirmed that the specific communication is an attack communication (“YES” in S303), anomaly handler 58 determines whether an influence of the attack communication remains in second region 38 (S304).

When it is determined that the influence of the attack communication remains in second region 38 (“YES” in S304), anomaly handler 58 executes the handling process on second region 38 (S305). Subsequently, the processing of the flowchart in FIG. 11 is terminated.

On the other hand, when it is determined that the influence of the attack communication does not remain in second region 38 (“NO” in S304), anomaly handler 58 does not execute the handling process on second region 38 (S306). Subsequently, the processing of the flowchart in FIG. 11 is terminated.

Returning to step S303, when it is not confirmed that the specific communication is an attack communication (“NO” in S303), anomaly handler 58 inspects the specific communication in detail (S307).

Next, as a result of inspecting the specific communication in detail, when it is determined that the specific communication is an attack communication (“YES” in S308), anomaly handler 58 proceeds to the above-mentioned step S304.

On the other hand, as a result of inspecting the specific communication in detail, when it is determined that the specific communication is not an attack communication (“NO” in S308), anomaly handler 58 determines whether it is necessary to execute the handling process on second region 38 (S309).

When it is determined that it is necessary to execute the handling process on second region 38 (“YES” in S309), anomaly handler 58 executes the handling process on second region 38 (S310). Subsequently, the processing of the flowchart in FIG. 11 is terminated.

On the other hand, when it is determined that it is not necessary to execute the handling process on second region 38 (“NO” in S309), anomaly handler 58 does not execute the handling process on second region 38 (S311). Subsequently, the processing of the flowchart in FIG. 11 is terminated.

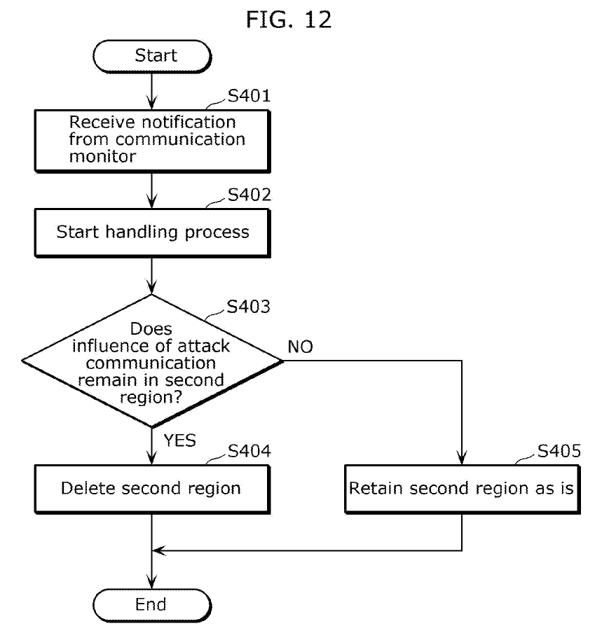

Next, operation of anomaly handler 58 in a case in which a specific communication is immediately blocked as the handling process in step S305 or step S310 of the flowchart in FIG. 11 will be described with reference to FIG. 12. FIG. 12 is a flowchart illustrating the flow of operation of anomaly handler 58 according to Embodiment 1 in a case in which a specific communication is immediately blocked.

As illustrated in FIG. 12, first, anomaly handler 58 receives notification from communication monitor 46 (S401).

Next, anomaly handler 58 starts performing a handling process on a specific communication based on the notification from communication monitor 46 (S402).

Next, anomaly handler 58 determines whether an influence of an attack communication remains in second region 38 (S403).

When it is determined that the influence of the attack communication remains in second region 38 (“YES” in S403), anomaly handler 58 deletes second region 38 (S404). Subsequently, the processing of the flowchart in FIG. 12 is terminated.

On the other hand, when it is determined that the influence of the attack communication does not remain in second region 38 (“NO” in S403), anomaly handler 58 retains second region 38 as is (S405). Subsequently, the processing of the flowchart in FIG. 12 is terminated.

### 4. Advantageous Effects

In the present embodiment, as described above, when an n-th stage filter among the multistage filters determines, as a result of inspecting the specific communication, that the specific communication is allowed to pass through to second region 38, (i) the specific communication is tentatively passed through to second region 38 while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one.

Accordingly, since the specific communication is tentatively passed through to the second region from an n-th stage filter, vehicle control function 52 of second region 38 does not need to be interrupted even when vehicle 4 is being driven. Furthermore, as a result of inspection of one or more filters from the (n + 1)-th stage filter and onward, even when an anomaly is identified in the specific communication, second region 38 can be notified of this after the fact. As a result, communication between first region 36 and second region 38 can be monitored while ensuring driving safety of vehicle 4.

### Embodiment 2

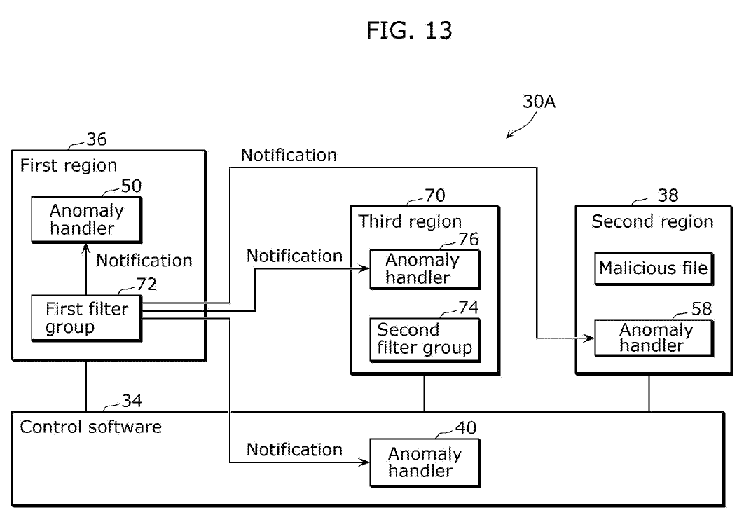

Next, a configuration of monitoring system 30A according to Embodiment 2 will be described with reference to FIG. 13. FIG. 13 is a block diagram illustrating a configuration of monitoring system 30A according to Embodiment 2. It should be noted that in the present embodiment, elements that are the same as elements in the above-mentioned Embodiment 1 are given the same reference signs and description thereof will be omitted.

As illustrated in FIG. 13, monitoring system 30A includes third region 70 in addition to first region 36 and second region 38. In other words, a vehicle system is logically separated into first region 36, second region 38, and third region 70.

First region 36 includes first filter group 72. First filter group 72 includes multistage filters, or in other words, a first filter and a second filter as described in the above-mentioned Embodiment 1.

Furthermore, third region 70 includes second filter group 74 and anomaly handler 76. Second filter group 74 includes multistage filters, or in other words, a third filter and a fourth filter as described in the above-mentioned Embodiment 1.

In the same manner as in the above-mentioned Embodiment 1, the first filter, the second filter, the third filter, and the fourth filter inspect a specific communication in this order. Specifically, after the specific communication is inspected by the first filter and the second filter, in this order, the specific communication is transmitted to the third filter. Next, the third filter and the fourth filter inspect the specific communication in this order. In other words, as a result of inspecting the specific communication, when it is determined that the specific communication is allowed to be passed through to second region 38, the first filter allows the specific communication to tentatively pass through to second region 38 while bypassing the second filter, the third filter, and the fourth filter. In parallel with this, the first filter copies the specific communication that is passed through to second region 38 for inspection purposes, and the specific communication copied is inspected by the second filter, the third filter, and the fourth filter in this order.

In this manner, even when the first filter, the second filter, the third filter, and the fourth filter described in Embodiment 1 are separated into first filter group 72 and second filter group 74, it is possible to achieve the same advantageous effect as the above-mentioned Embodiment 1.

Note that when an anomaly is detected in the specific communication, first filter group 72 notifies anomaly handler 50 of first region 36, anomaly handler 58 of second region 38, anomaly handler 40 of control software 34, and anomaly handler 76 of third region 70 of this matter.

### Other Variations

While a monitoring system according to one or more aspects has been described based on the above-mentioned embodiments, the present disclosure is not limited to the above-mentioned embodiments. Forms obtained by various modifications to the foregoing embodiments conceivable by those skilled in the art or forms obtained by combining elements in different embodiments, so long as they do not depart from the essence of the present disclosure, may be included in the one or more aspects.

In the above-mentioned embodiments, each element may be configured as dedicated hardware, or may be implemented by executing a computer program suitable for each element. Each element may be implemented by a program executor, such as a central processing unit (CPU) or a processor or the like reading and executing a computer program recorded on a recording medium, such as a hard disk or a semiconductor memory or the like.

Furthermore, a portion or all of the functions of the control device according to the above-mentioned embodiments may be implemented by a processor, such as a CPU, executing a computer program.

A portion or all of the elements included in the preceding devices may be configured as an IC card or stand-alone module that can be inserted and removed from the corresponding device. The IC card or the module is a computer system that includes a microprocessor, ROM, RAM, and the like. The IC card or the module may include the super-multifunctional LSI described above. The microprocessor operates according to the computer program, so that a function of the IC card or the module is achieved. The IC card or the module may be tamper-resistant.

The present disclosure may be the method described above. Furthermore, the present disclosure may be a computer program for causing a computer to execute the method, or may be a digital signal of the computer program. Additionally, the present disclosure may be the above-mentioned computer program or the digital signal recorded on a non-transitory, computer-readable recording medium, such as a flexible disk, a hard disk, a compact disc (CD)-ROM, a magneto-optical (MO) disc, a digital video disc (DVD), a DVD-ROM, a DVD-RAM, a BD (Blu-ray Disc (registered trademark)), or a semiconductor memory, for example. Moreover, the present disclosure may be the digital signal recorded on the above-mentioned recording media. Furthermore, the present disclosure may be the above-mentioned computer program or the digital signal transmitted via an electric communication line, a wireless or wired communication line, a network, such as the Internet, data broadcasting, and the like. Additionally, the present disclosure may be a computer system including a microprocessor and memory. The memory may store the above-mentioned computer program, and the microprocessor may operate according to the computer program. Moreover, by transferring the recording medium having the above-mentioned computer program or digital signal recorded thereon or by transferring the above-mentioned computer program or digital signal via the above-mentioned network or the like, the present disclosure may be implemented by a different independent computer system.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in its entirety: Japanese Patent Application No. 2025-052852 filed on Mar. 27, 2025.

### INDUSTRIAL APPLICABILITY

The monitoring system according to the present disclosure is applicable to an autonomous driving system or the like in a vehicle, for example.

1. A monitoring system that monitors a vehicle system logically separated into a first region and a second region that has a security level higher than a security level of the first region, the monitoring system comprising:
an interregional communicator that controls communication between the first region and the second region; and
a communication monitor that monitors the communication between the first region and the second region, wherein
the communication monitor includes multistage filters that sequentially inspect a specific communication in which the first region is a transmission source and the second region is a destination, and
when an n-th stage filter among the multistage filters determines, as a result of inspecting the specific communication, that the specific communication is allowed to pass through to the second region, (i) the specific communication is passed through to the second region while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one.

2. The monitoring system according to claim 1, wherein
when the specific communication is determined to be anomalous as a result of the multistage filters inspecting the specific communication, the communication monitor provides notification that the specific communication is anomalous.

3. The monitoring system according to claim 2, further comprising:
an anomaly handler that executes a handling process on the specific communication based on the notification that the specific communication is anomalous from the communication monitor.

4. The monitoring system according to claim 3, wherein
the vehicle system is further logically separated into the first region, the second region, and an inspection region isolated from the first region and the second region, and
when the specific communication is a transmission of a malicious file from the first region to the second region, as the handling process, the anomaly handler moves the malicious file from the second region to the inspection region, and inspects the malicious file in the inspection region.

5. The monitoring system according to claim 4, wherein
after inspecting the malicious file in the inspection region, the anomaly handler deletes the inspection region.

6. The monitoring system according to claim 3, wherein
when the specific communication is a transmission of a malicious file from the first region to the second region, as the handling process, the anomaly handler deletes the second region together with the malicious file, and generates a third region that has a function identical to a function of the second region.

7. The monitoring system according to claim 1, wherein
the multistage filters sequentially inspect the specific communication based on a state of a vehicle in which the vehicle system is provided.

8. A control method for use in a monitoring system that monitors a vehicle system logically separated into a first region and a second region that has a security level higher than a security level of the first region, the control method comprising:
controlling communication between the first region and the second region; and
monitoring the communication between the first region and the second region, wherein
in the monitoring, when multistage filters are used to sequentially inspect a specific communication in which the first region is a transmission source and the second region is a destination, and an n-th stage filter among the multistage filters determines, as a result of inspecting the specific communication, that the specific communication is allowed to pass through to the second region, (i) the specific communication is passed through to the second region while bypassing one or more filters from an (n + 1)-th stage filter and onward among the multistage filters, and in parallel with (i), (ii) the specific communication is inspected by the one or more filters from the (n + 1)-th stage filter and onward, n being an integer greater than or equal to one.
